(19) United States
(12) Patent Application Publication
(10) Pub. No.: US 2025/0128533 A1
(43) Pub. Date: Apr. 24, 2025

(54) Transfer Recording Method

(71) Applicant: SEIKO EPSON CORPORATION, Tokyo (JP)

(72) Inventors: Seiichi MATSUSHIMA, Matsumoto (JP); Haruka SATO, Shiojiri (JP)

(21) Appl. No.: 18/918,260

(22) Filed: Oct. 17, 2024

(30) Foreign Application Priority Data
Oct. 18, 2023 (JP) 2023-179766

(51) Int. Cl. B41M 5/035; B41M 3/00; B41M 5/00; B41M 5/025; C09D 11/104; C09D 11/107; C09D 11/30; C09D 11/54; D06P 1/52; D06P 5/24

(52) U.S. Cl. CPC B41M 5/0356; B41M 3/008; B41M 5/0047; B41M 5/0256; C09D 11/104; C09D 11/107; C09D 11/30; C09D 11/54; D06P 1/5235; D06P 1/525; D06P 1/5271; D06P 1/5285; D06P 5/007; B41M 2205/02

(57) ABSTRACT

A transfer recording method includes a first layer forming step of discharging an image forming ink from an ink jet head onto a transfer medium having a release layer to form a first layer, a second layer forming step of discharging an adhesive ink from the ink jet head to form a second layer so as to be superimposed on the first layer, and a thermal transfer step of thermally transferring the first layer and the second layer onto fabric by heating a surface of the transfer medium on which the first layer and the second layer are formed in a state where the surface faces the fabric, in which the image forming ink includes a color material and water, the adhesive ink includes a thermoplastic resin and water, the softening point of the thermoplastic resin is equal to or lower than the temperature for heating the fabric in the thermal transfer step, the solid content of the thermoplastic resin is 5% by mass or more and 25% by mass or less based on the total amount of the adhesive ink, the application amount of the adhesive ink in the second layer forming step is 38 g/m² or more, and the sum of the application amount of the image forming ink in the first layer forming step and the application amount of the adhesive ink in the second layer forming step is 212 g/m² or less.

The present application is based on, and claims priority from JP Application Serial Number 2023-179766, filed Oct. 18, 2023, the disclosure of which is hereby incorporated by reference herein in its entirety.

### BACKGROUND

### 1. Technical Field

The present disclosure relates to a transfer recording method.

### 2. Related Art

A transfer printing method in which a transfer sheet, which is a transfer medium on which an image is formed, is overlaid on fabric such as cloth, and the image is transferred onto the fabric through application of heat and pressure has been known. In such a method, an ink jet method is often used when the image is formed on the transfer sheet, because it is advantageous in forming a fine image with high on-demand performance.

In the transfer printing method as described above, in general, an image is formed on a transfer sheet in which a release layer and a hot melt layer are formed on the entire surface of a base material, and heat and pressure are then applied to the transfer sheet to transfer the image onto fabric.

JP-A-2012-126025 discloses a method of producing a transfer medium, the method including a colored layer forming step of discharging an ink from an ink jet head toward a base material to form a colored layer on the base material, and an adhesive layer forming step of discharging an adhesive liquid from the ink jet head toward the colored layer to form an adhesive layer on the colored layer, in which white ink is deposited so as to cover the surface of an image of CMYK ink in the colored layer forming step. JP-A-2012-126025 indicates that in a case where the ink is an aqueous image forming ink, when 65% to 95% by mass of the liquid component included in the ink is evaporated, the pattern of the colored layer can be obtained with high resolution, and transferability becomes also good.

In the technique of JP-A-2012-126025, plastic or metal is used as a transfer substrate. However, studies on transfer conditions suitable for transfer onto fabric have been not enough. In addition, since the amount of ink deposited usually varies by region in a transfer pattern requiring high resolution, it has been difficult to suitably adjust the evaporation ratio of the liquid component in all regions. Therefore, a method capable of recording in high image quality regardless of the evaporation ratio of the liquid component has been needed.

### SUMMARY

An aspect of a transfer recording method according to the present disclosure is a transfer recording method including a first layer forming step of discharging an image forming ink from an ink jet head onto a transfer medium having a release layer to form a first layer, a second layer forming step of discharging an adhesive ink from the ink jet head to form a second layer so as to be superimposed on the first layer, and a thermal transfer step of thermally transferring the first layer and the second layer onto fabric by heating a surface of the transfer medium on which the first layer and the second layer are formed in a state where the surface faces the fabric, in which the image forming ink includes a color material and water, the adhesive ink includes a thermoplastic resin and water, the softening point of the thermoplastic resin is equal to or lower than the temperature for heating the fabric in the thermal transfer step, the solid content of the thermoplastic resin is 5% by mass or more and 25% by mass or less based on the total amount of the adhesive ink, the application amount of the adhesive ink in the second layer forming step is 38 g/m² or more, and the sum of the application amount of the image forming ink in the first layer forming step and the application amount of the adhesive ink in the second layer forming step is 212 g/m² or less.

### BRIEF DESCRIPTION OF THE DRAWINGS

FIGS. 1A-1D are schematic views illustrating schematic steps of a transfer recording method according to an embodiment.

FIG. 2 is Table 1 showing compositions of adhesive inks for Examples, Comparative Examples, and Reference Example.

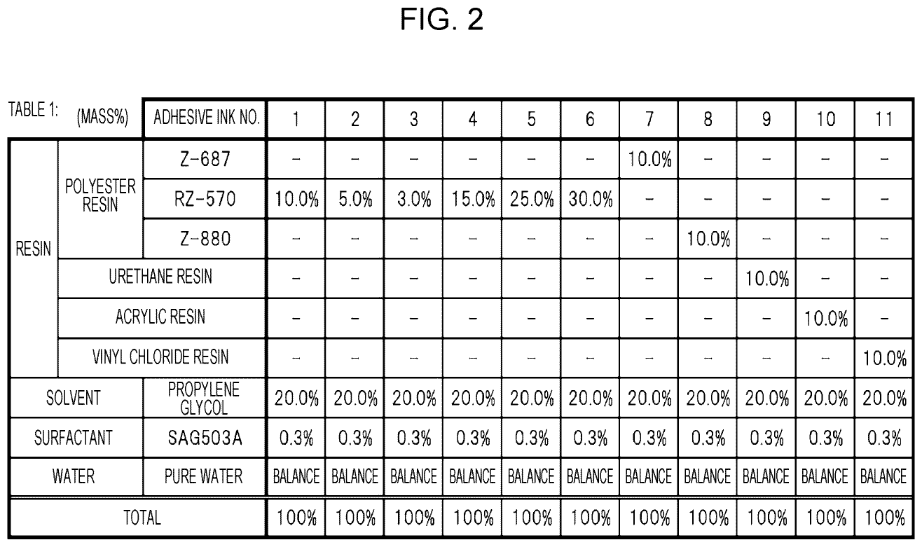

FIG. 3 is Table 2 showing compositions of image forming inks for Examples, Comparative Examples, and Reference Example.

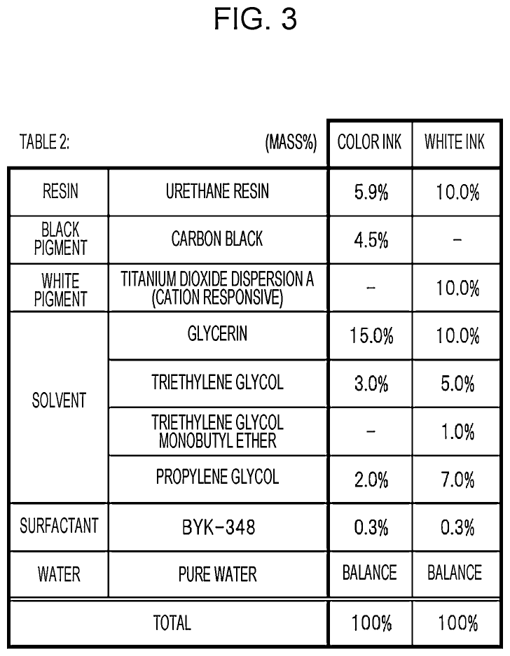

FIG. 4 is Table 3 showing conditions and evaluation results of a transfer recording method according to each of Examples.

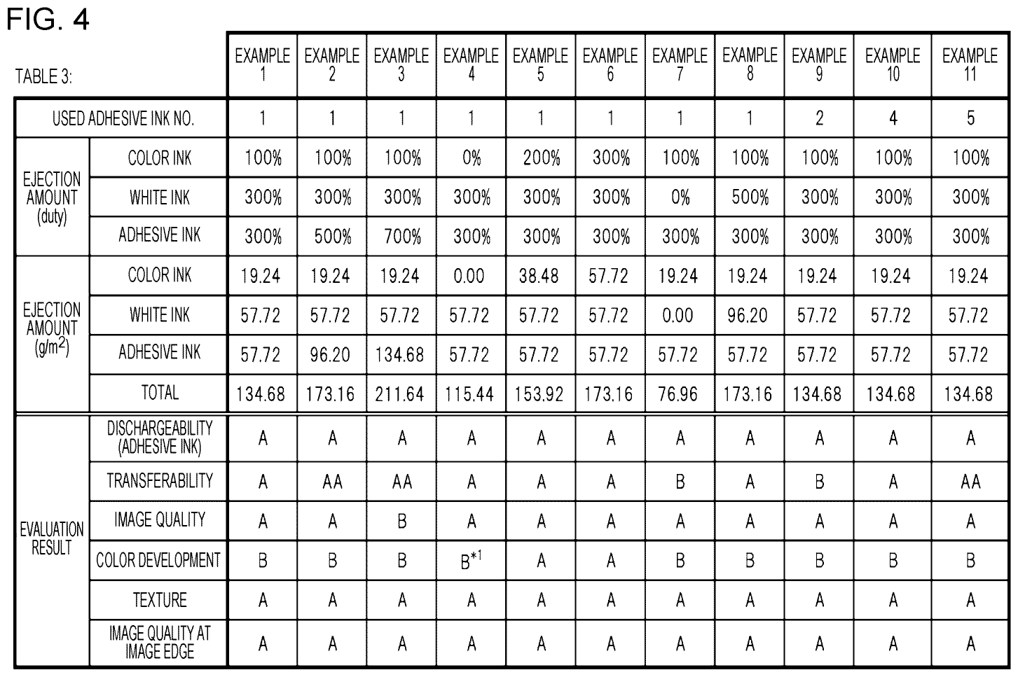

FIG. 5 is Table 4 showing conditions and evaluation results of a transfer recording method according to each of Examples, Comparative Examples, and Reference Example.

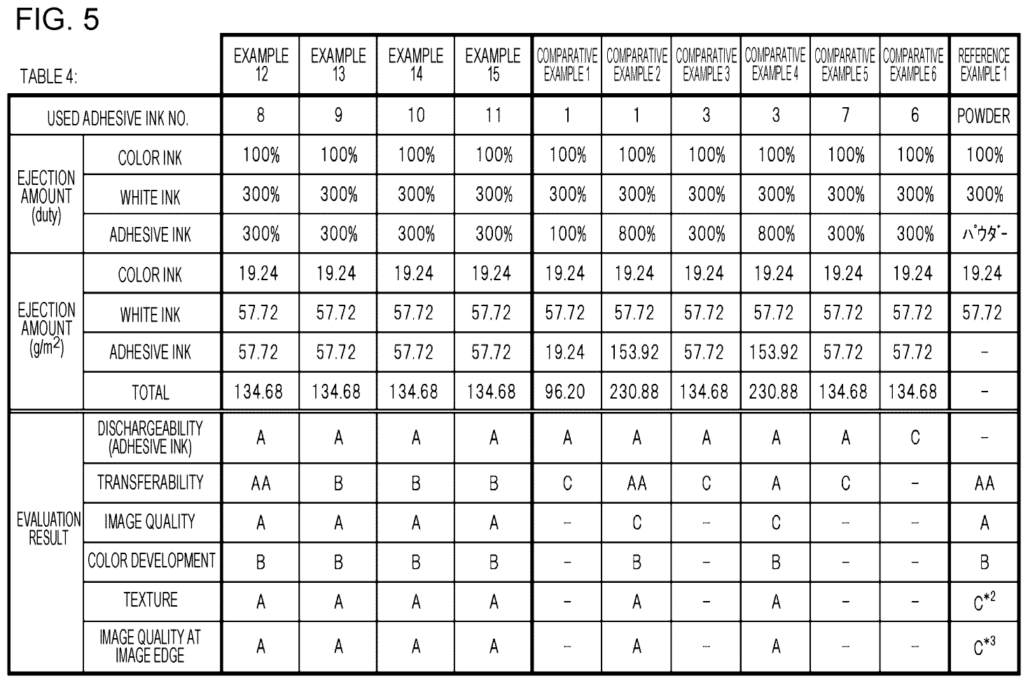

### DESCRIPTION OF EMBODIMENT

Hereinafter, an embodiment of the present disclosure will be described. The embodiment described below explains examples of the present disclosure. The present disclosure is not limited to the following embodiment, and includes various modifications that are carried out within a range not changing the spirit of the present disclosure. Note that not all of constituents described below are essential constituents of the present disclosure.

### 1. Transfer Recording Method

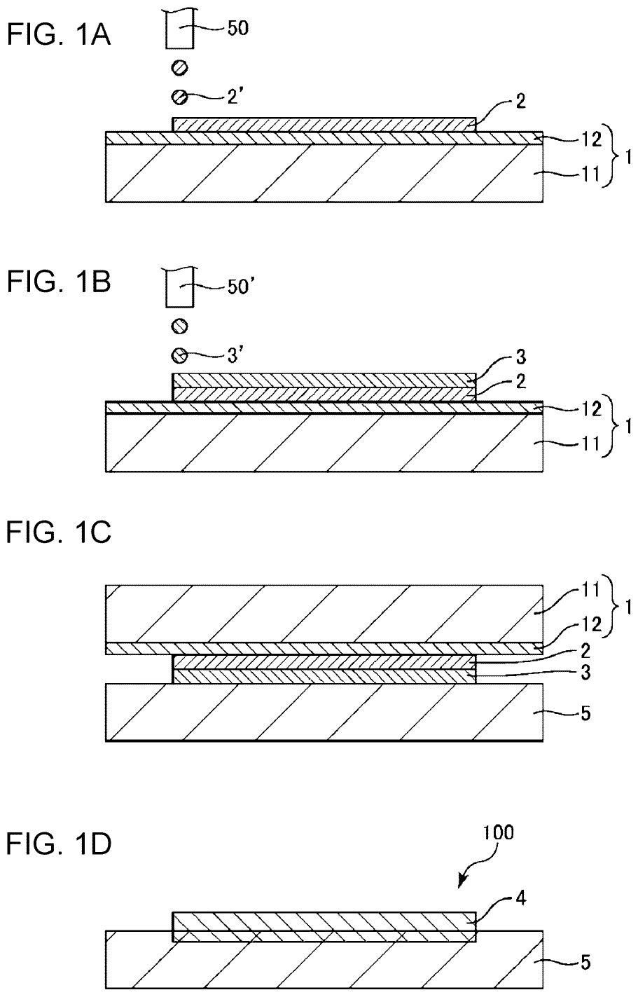

A transfer recording method according to the present embodiment includes a first layer forming step of discharging an image forming ink from an ink jet head onto a transfer medium having a release layer to form a first layer, a second layer forming step of discharging an adhesive ink from the ink jet head to form a second layer so as to be superimposed on the first layer, and a thermal transfer step of thermally transferring the first layer and the second layer onto fabric by heating a surface of the transfer medium on which the first layer and the second layer are formed in a state where the surface faces the fabric. FIGS. 1A-1D are schematic views illustrating schematic steps of a transfer recording method according to the present embodiment.

### 1. 1. First Layer Forming Step

In the first layer forming step, the image forming ink is discharged from the ink jet head onto the transfer medium having the release layer to form the first layer.

### 1. 1. 1. Transfer Medium

A transfer medium 1 is not limited as long as it has a release layer 12. In the illustrated example, the transfer medium 1 has a base material 11 and the release layer 12. Although the shape of the transfer medium 1 is not particularly limited, a sheet-shaped medium is preferably used. Consequently, a first layer 2 and a second layer 3 can be more preferably formed by an ink jet method. When the base material 11 has a sheet shape, the thickness of the base material 11 is, for example, 25 μm or more and 300 μm or less and is preferably 50 μm or more and 200 μm or less.

Examples of a constituent material of the base material 11 include paper, a plastic material, and a metal material. Examples of the plastic material constituting the base material 11 include a polyesters such as polyethylene terephthalate, and a polyolefin such as polyethylene and polypropylene.

The release layer 12 is a layer having releasability. When the transfer medium 1 has the release layer 12, constituent materials of the first layer 2 and the second layer 3 can be prevented from remaining on the transfer medium 1 after the thermal transfer step. Examples of a constituent material of the release layer 12 include a polyethylene wax-based release agent, a silicone-based release agent, and a fluorine-based release agent. The thickness of the release layer 12 is not particularly limited, but is preferably 5 μm or more and 80 μm or less and more preferably 10 μm or more and 50 μm or less.

### 1. 1. 2. Image Forming Ink

The image forming ink includes a color material and water.

### (1) Color Material

Examples of the color material included in an image forming ink 2′ can include various inorganic pigments and organic pigments. Two or more components may be used in combination as a pigment.

Examples of the inorganic pigments include varieties of carbon black such as furnace black, lamp black, acetylene black, and channel black, iron oxide, and titanium oxide.

Examples of the organic pigments include azo pigments such as an insoluble azo pigment, a condensed azo pigment, azo lake, and a chelated azo pigment; polycyclic pigments such as a phthalocyanine pigment, a perylene pigment and a perinone pigment, an anthraquinone pigment, a quinacridone pigment, a dioxane pigment, a thioindigo pigment, an isoindolinone pigment, and a quinophthalone pigment; dye chelates such as a basic dye-type chelate and an acidic dye-type chelate; dye lake such as basic dye-type lake and acidic dye-type lake; nitro pigments; nitroso pigments; aniline black; and daylight fluorescent pigments.

Examples of carbon black used as a black pigment include No. 2300, No. 900, MCF88, No. 33, No. 40, No. 45, No. 52, MA7, MA8, MA100, and No. 2200B (all of the above are manufactured by Mitsubishi Chemical Corporation); Raven 5750, Raven 5250, Raven 5000, Raven 3500, Raven 1255, and Raven 700 (all of the above are manufactured by Columbia Carbon corporation), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all of the above are manufactured by Cabot Corporation); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all of the above are manufactured by Degussa AG).

Examples of a white pigment include C.I. Pigment White 6, 18, and 21.

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a reddish purple pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of an indigo purple pigment include C.I. pigment blue 1, 2, 3, 15, 15:1, 15:2, 15:3, 15:34, 15:4, 16, 18, 22, 25, 60, 65, and 66, and C.I. Vat Blue 4 and 60.

Examples of pigments of other colors include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

The image forming ink 2′ may include a self-dispersing pigment as the pigment. The self-dispersing pigment has a hydrophilic group on a surface of the pigment, and examples of the hydrophilic group include —OM, —COOM, —CO—, —SO₃M, —SO₂M, —SO₂NH₂, —RSO₂M, —PO₃HM, —PO₃M₂, —SO₂NHCOR, —NH₃, and—NR₃. In the formulae, M represents a hydrogen atom, an alkali metal, ammonium, or an organic ammonium, and R represents an alkyl group having 1 to 12 carbon atoms or a naphthyl group which may have a substituent. In addition, a phenyl group may be present between the surface of the pigment and the hydrophilic group, for example.

The self-dispersing pigment can be produced by, for example, subjecting the pigment to a physical treatment or a chemical treatment to bind the hydrophilic group to the surface of the pigment. Examples of such a physical treatment include a vacuum plasma treatment. In addition, examples of the chemical treatment include a wet oxidation method in which oxidation is carried out with an oxidizing agent in water.

As the self-dispersing pigment, for example, a self-dispersing pigment surface-treated by an oxidation treatment with a hypohalous acid and/or a hypohalite, by an oxidation treatment with ozone, or by an oxidation treatment with persulfuric acid and/or a persulfate is preferable from the viewpoint of high color development. As the self-dispersing pigment, a commercially available product can also be used, and preferable examples thereof include Microjet CW1 (manufactured by ORIENT CHEMICAL INDUSTRIES CO., LTD.), and CAB-O-JET250C, CAB-O-JET260M, CAB-O-JET270Y, and CAB-O-JET444MP (all of the above are manufactured by Cabot Corporation).

The content of the pigment in the image forming ink 2′ is not particularly limited, but is preferably 1.0% by mass or more and 25.0% by mass or less, more preferably 2.0% by mass or more and 20.0% by mass or less, and still more preferably 5.0% by mass or more and 15.0% by mass or less.

Consequently, sufficient color density can be easily secured in a recording portion 4 formed using the image forming ink 2′, color developability on fabric can be made more excellent, and storage stability of the image forming ink 2′, discharge stability in an ink jet method, recovery properties from clogging in an ink jet head, and the like can be made more excellent.

### (2) Water

The image forming ink 2′ includes water. Examples of the type of water include pure water such as ion-exchanged water, ultrafiltered water, reverse osmosis water, and distilled water, and water from which ionic impurities are removed as much as possible, such as ultrapure water. In addition, when water sterilized by ultraviolet irradiation, addition of hydrogen peroxide, or the like is used, occurrence of bacteria and fungi can be reduced when the composition is stored for a long period of time.

Water functions as a dispersion medium for dispersing the pigment in the image forming ink 2′. The content of water in the image forming ink 2′ is preferably 50.0% by mass or more and 75.0% by mass or less, more preferably 52.0% by mass or more and 70.0% by mass or less, and still more preferably 54.0% by mass or more and 65.0% by mass or less.

### (3) Other Components

### (3-1) Organic Solvent

The image forming ink 2′ may include an organic solvent. Consequently, the viscosity and the surface tension of the image forming ink 2′ can be suitably adjusted. In addition, for example, moisture-retaining properties of the image forming ink 2′ become excellent, the solid content of the image forming ink 2′ is more effectively prevented from being unintentionally precipitated due to drying or the like in an ink jet head or the like, clogging recovery properties can be made more excellent, and discharge stability of the image forming ink 2′ can be made more excellent.

As the organic solvent, a water-soluble organic solvent is preferably used. As such a water-soluble organic solvent, an organic solvent having solubility in water of 10 g per 100 g of water or more at 25° C. can be suitably used.

Examples of the organic solvent, particularly the water-soluble organic solvent included in the image forming ink 2′ include a polyol compound, a glycol ether, and a cyclic amide compound, and one kind selected from these solvents or a combination of two or more kinds thereof can be used.

Specific examples of the polyol compound include glycols such as 1,2-pentanediol, glycerin, ethylene glycol, diethylene glycol, triethylene glycol, polyethylene glycol, propylene glycol, dipropylene glycol, tripropylene glycol, polypropylene glycol, polyoxyethylene polyoxypropylene glycol, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,5-pentanediol, 1,6-hexanediol, 2-methyl-2,4-pentanediol, and 3-methyl-1,5-pentanediol.

Examples of the glycol ether include monoalkyl ethers of a glycol selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. Examples of the monoalkyl ethers include triethylene glycol monomethyl ether, triethylene glycol monobutyl ether, triethylene glycol monoethyl ether, and dipropylene glycol monopropyl ether.

Examples of the cyclic amide compound include 2-pyrrolidone, N-methyl-2-pyrrolidone, N-hydroxyethyl-2-pyrrolidone, 1,3-dimethylimidazolidinone, 2-piperidone (δ-valerolactam), and N-cyclohexyl-2-pyrrolidone.

The content of the organic solvent in the image forming ink 2′ is preferably 5.0% by mass or more and 35.0% by mass or less, more preferably 10.0% by mass or more and 30.0% by mass or less, and still more preferably 15.0% by mass or more and 25.0% by mass or less.

Consequently, the viscosity and the surface tension of the image forming ink 2′ can be more suitably adjusted. In addition, moisture-retaining properties of the image forming ink 2′ become more excellent, the solid content of the image forming ink 2′ is more effectively prevented from being unexpectedly precipitated due to drying or the like in an ink jet head or the like, clogging recovery properties can be made more excellent, and discharge stability of the image forming ink 2′ can be made more excellent.

### (3-2) Thermoplastic Resin

The image forming ink 2′ may include a thermoplastic resin. Consequently, adhesiveness of the recording portion 4 including the pigment to fabric 5 can be made more excellent. In addition, transferability resulting from the thermoplastic resin included in the image forming ink can be exhibited. That is, in addition to transferability of an adhesive ink described later, transferability of an image can be improved. In addition, the texture of a recorded matter 100 produced can be made excellent.

The content of the thermoplastic resin in the image forming ink 2′ may be 15.0% by mass or less, and the image forming ink 2′ may include no resin. However, the content of the thermoplastic resin in the image forming ink 2′ is preferably 2.0% by mass or more and 13.0% by mass or less, more preferably 4.0% by mass or more and 12.0% by mass or less, and still more preferably 7.0% by mass or more and 11.0% by mass or less.

The form of the thermoplastic resin in the image forming ink 2′ is not particularly limited. For example, in the image forming ink 2′, the thermoplastic resin may be included in a dispersed state or may be included in a dissolved state, for example, but is preferably included in a dispersed state.

When the thermoplastic resin is included in the image forming ink 2′ in a dispersed state, the average particle diameter thereof is preferably 30 nm or more and 3 μm or less, more preferably 50 nm or more and 1 μm or less, and still more preferably 60 nm or more and 300 nm or less.

In the present specification, the average particle diameter refers to a volume-based average particle diameter, and can be obtained by, for example, adding a sample to methanol and dispersing the sample with an ultrasonic dispersion device for three minutes to obtain a dispersion liquid, and subjecting the dispersion liquid to measurement with a Coulter counter particle size distribution measurement device (TA-II model, manufactured by COULTER ELECTRONICS INS) using an aperture of 50 μm.

Examples of the thermoplastic resin included in the image forming ink 2′ include polyurethane, polyester, styrene acrylic resin, acrylic resin, and polyvinyl chloride, and one kind selected from these resins or a combination of two or more kinds thereof can be used. Among them, polyurethane is preferable.

The glass transition temperature of the thermoplastic resin included in the image forming ink 2′ is preferably −40° C. or higher and 0° C. or lower, more preferably −35° C. or higher and −5° C. or lower, and still more preferably −30° C. or higher and −10° C. or lower. Consequently, the texture, washing fastness, and the like of the recorded matter 100 produced can be made more excellent.

In the case where the image forming ink 2′ includes the thermoplastic resin, when the content of the thermoplastic resin in the image forming ink 2′ is denoted as XR [mass %] and the content of the color material in the image forming ink 2′ is denoted as XP [mass %], the relationship therebetween satisfies preferably 0.2≤XR/XP≤1.8, more preferably 0.6≤XR/XP≤1.5, and still more preferably 0.8≤XR/XP≤1.2.

Consequently, sufficient color density can be easily secured in the recording portion 4 formed using the image forming ink 2′, color developability on fabric can be made more excellent, and storage stability of the image forming ink 2′, discharge stability in an ink jet method, recovery properties from clogging in an ink jet head, and the like can be made more excellent. In addition, the texture of the recorded matter 100 and adhesiveness of the recording portion 4 to the fabric 5 can be made more excellent.

### (3-3) Surfactant

The image forming ink 2′ may include a surfactant. As the surfactant, for example, various surfactants such as an anionic surfactant, a cationic surfactant, and a nonionic surfactant can be used.

When the image forming ink 2′ includes a surfactant, the content of the surfactant in the image forming ink 2′ is preferably 0.02% by mass or more and 1.50% by mass or less, more preferably 0.05% by mass or more and 1.00% by mass or less, and still more preferably 0.10% by mass or more and 0.70% by mass or less.

### (3-4) Other Components

The image forming ink 2′ may include components other than the components described above. Hereinafter, in this item, such components are also referred to as the “other components.”

The other components include, for example, a chelating agent; a preservative; a fungicide; a rust inhibitor; a flame retardant; various dispersants; a pH adjusting agent such as triethanolamine; a dye; an antioxidant; an ultraviolet absorber; an oxygen absorber; a dissolution aid; and a penetrant.

Examples of the chelating agent include ethylenediamine tetraacetate. Examples of the preservative and fungicide include sodium benzoate, sodium pentachlorophenol, sodium 2-pyridinethiol-1-oxide, sodium sorbate, sodium dehydroacetate, 1,2-dibenzoisothiazolin-3-one, and 4-chloro-3-methylphenol. Examples of the rust inhibitor include benzotriazole. As the preservative and fungicide, for example, a compound having an isothiazoline ring structure within a molecule can be used.

The content of the other components in the image forming ink 2′ is preferably 6.0% by mass or less and more preferably 5.0% by mass or less.

### (4) Physical Properties, Etc.

The viscosity of the image forming ink 2′ at 25° C. is preferably 2 mPa·s or more and 10 mPa·s or less and more preferably 3 mPa·s or more and 8 mPa·s or less. Consequently, clogging or the like of a nozzle of an ink jet head is less likely to occur, and discharge stability of the image forming ink 2′ is further improved. In addition, recovery properties from clogging in a nozzle can be made more excellent.

Incidentally, the viscosity can be determined through measurement with a vibration type viscometer, a rotary type viscometer, a capillary type viscometer, or a falling-ball viscometer. For example, the viscosity can be determined through measurement with a vibration type viscometer in accordance with JIS Z8809.

The surface tension of the image forming ink 2′ at 25° C. is not particularly limited, but is preferably 20 mN/m or more and 60 mN/m or less, more preferably 25 mN/m or more and 50 mN/m or less, and still more preferably 27 mN/m or more and 40 mN/m or less.

Consequently, clogging or the like of a nozzle of an ink jet head is less likely to occur, and discharge stability of the image forming ink 2′ is further improved. In addition, recovery properties from clogging in a nozzle can be made more excellent.

Incidentally, a value obtained through measurement with the Wilhelmy method or the ring method can be employed as the surface tension. The surface tension can be measured using a surface tensiometer (for example, DY-300, DY-500, DY-700, and the like manufactured by Kyowa Interface Science Co., Ltd).

### 1. 1. 3. Discharge in Ink Jet Method

The first layer 2 is formed by discharging the image forming ink 2′ onto the transfer medium 1 having the release layer 12 by an ink jet method. More specifically, the image forming ink 2′ is discharged so as to be deposited on the release layer 12 of the transfer medium 1.

Examples of the ink jet method include an on-demand method such as a charge deflection method, a continuous method, a piezoelectric method, and a bubblejet (registered trademark) method, and a piezoelectric method in which ink is discharged from an ink jet head using a piezoelectric oscillator is particularly preferable. Consequently, denaturation and the like of the constituent components of the image forming ink 2′ within an ink jet head 50 can be reduced, and discharge stability in the ink jet method can be made more excellent.

The ink jet head 50 includes a line head for recording in a line method and a serial head for recording in a serial method.

In the line method using a line head, an ink jet head having a width equal to or more than the recording width of the transfer medium 1 is fixed to a recording device, for example. Then, the transfer medium 1 is moved along the vertical scanning direction (transporting direction of the transfer medium 1), and ink droplets are discharged from a nozzle of the ink jet head 50 in conjunction with this movement to form the first layer 2 on the transfer medium 1.

In the serial method using a serial head, the ink jet head 50 is mounted to a carriage capable of moving in the width direction of the transfer medium 1, for example. Then, the carriage is moved along the main scanning direction (width direction of the transfer medium 1), and ink droplets are discharged from a nozzle of the serial head, which is the ink jet head 50, in conjunction with this movement to form the first layer 2 on the transfer medium 1.

In this step, the first layer 2 is formed as an inverted image of the recording portion 4 to be formed on the fabric 5. In addition, in this step, a plurality of types of the image forming ink 2′ may be used. For example, a plurality of types of the image forming ink 2′ having different color tones, more specifically, black ink, cyan ink, magenta ink, and yellow ink may be used.

For example, in the first layer forming step, the first layer may be formed by discharging a first image forming ink including a chromatic color material and a second image forming ink including a white pigment in a superimposed manner. In this way, when the second image forming ink (white ink) is discharged in a superimposed manner in addition to the first image forming ink (color ink), the total amount of deposited ink increases. Therefore, image bleeding is suppressed, allowing for formation of a high-quality image even in such a case.

### 1. 2. Second Layer Forming Step

In the second layer forming step, the adhesive ink is discharged from the ink jet head to form the second layer so as to be superimposed on the first layer.

### 1. 2. 1. Adhesive Ink

An adhesive ink 3′ is used to form a second layer 3 and includes a thermoplastic resin and water.

### (1) Thermoplastic Resin

When the adhesive ink 3′ includes a thermoplastic resin, adhesiveness of the recording portion 4 to the fabric 5 can be made excellent, and washing fastness of the recorded matter 100 produced can be made excellent.

The thermoplastic resin included in the adhesive ink 3′ is the same as that described in item “(3-2) Thermoplastic resin” in “1. 1. 2. Image forming ink,” and thus description thereof will be omitted.

The thermoplastic resin included in the adhesive ink 3′ is more preferably one or more kinds selected from a polyester resin, a urethane resin, an acrylic resin, and a vinyl chloride resin. Consequently, transfer of an image can be performed more favorably.

The melting point of the thermoplastic resin included in the adhesive ink 3′ is preferably 80° C. or higher and 140° C. or lower, more preferably 85° C. or higher and 130° C. or lower, and still more preferably 90° C. or higher and 120° C. or lower. Consequently, both the texture and washing fastness of the recorded matter 100 can be achieved at a higher level.

The softening point of the thermoplastic resin is preferably equal to or lower than the temperature at which fabric is heated in the thermal transfer step. The softening point of the thermoplastic resin is preferably 80° C. or higher and 170° C. or lower, more preferably 90° C. or higher and 160° C. or lower, and still more preferably 100° C. or higher and 150° C. or lower. When the softening point of the thermoplastic resin falls within this range, tackiness of a transfer substrate can be further suppressed, and damage to fabric due to heat during thermal transfer can be further reduced.

The softening point of the thermoplastic resin can be measured by using, for example, a dropping/softening point instrument “Dropping Point System DP70” manufactured by Mettler Toledo, Inc. The outline of the measurement is as follows: a substance is heated until the state thereof changes from a solid state to a liquid state, and the temperature at which the substance flows a certain distance is measured under predetermined measurement conditions. In the softening point measurement, a dedicated sample cup with an opening of 6.35 mm at the bottom part thereof is used, and the resin is weighed with a stainless steel ball having a standardized dimension in order to lower the softened resin from the cup during heating. The temperature of the heating furnace when the resin softens and descends 19 mm below the orifice of the cup is recorded as the softening point temperature of the resin.

The solid content of the thermoplastic resin in the adhesive ink 3′ is 5% by mass or more and 25% by mass or less based on the total amount of the adhesive ink 3′. The solid content of the thermoplastic resin in the adhesive ink 3′ is preferably 5.0% by mass or more and 20.0% by mass or less, more preferably 6.0% by mass or more and 17.0% by mass or less, and still more preferably 7.0% by mass or more and 15.0% by mass or less. Consequently, both the texture and washing fastness of the recorded matter 100 can be achieved at a higher level.

### (2) Water

The adhesive ink 3′ includes water. Water is a component that functions as, for example, a dispersion medium for dispersing the resin or a solvent for dissolving the resin in the adhesive ink 3′. Water is the same as that described in item “(2) Water” in “1. 1. 2. Image forming ink,” and thus description thereof will be omitted.

The content of water in the adhesive ink 3′ is preferably from 50.0% by mass or more and 85.0% by mass or less, more preferably 55.0% by mass or more and 80.0% by mass or less, and still more preferably 60.0% by mass or more and 75.0% by mass or less.

### (3) Organic Solvent, Surfactant, and Other Components

The adhesive ink 3′ may include at least one of an organic solvent, a surfactant, and other components. Since these components are the same as those described in items “(3-1) Organic solvent,” “(3-3) Surfactant,” and “(3-4) Other components” in “1. 1. 2. Image forming ink,” respectively, description thereof will be omitted.

### 1. 2. 2. Physical Properties, Etc.

The viscosity of the adhesive ink 3′ at 25° C. is preferably 2 mPa·s or more and 10 mPa's or less and more preferably 3 mPa·s or more and 8 mPa·s or less. Consequently, clogging or the like of a nozzle of an ink jet head is less likely to occur, and discharge stability of the adhesive ink 3′ is further improved.

The surface tension of the adhesive ink 3′ at 25° C. is not particularly limited, but is preferably 20 mN/m or more and 60 mN/m or less, more preferably 25 mN/m or more and 50 mN/m or less, and still more preferably 27 mN/m or more and 40 mN/m or less. Consequently, clogging or the like of a nozzle of an ink jet head is less likely to occur, and discharge stability of the adhesive ink 3′ is further improved.

### 1. 2. 3. Discharge in Ink Jet Method

The second layer 3 is formed, by an ink jet method, by discharging the adhesive ink 3′ onto the transfer medium 1 on which the first layer 2 is formed. That is, the second layer 3 is formed to be superimposed on the first layer 2. The ink jet method is the same as that described in section “1. 1. 3. Discharge in ink jet method,” and thus description thereof will be omitted. The ink jet method is more preferably a piezoelectric method in which ink is discharged from an ink jet head using a piezoelectric oscillator. Consequently, denaturation and the like of the constituent components of the adhesive ink 3′ within an ink jet head 50′ can be more reduced, and discharge stability in the ink jet method can be made more excellent.

Although the time from the deposition of a pigment ink 2′ on the transfer medium 1 to the deposition of an adhesive ink 3′ varies depending on the composition or the like of the pigment ink 2′, the time is preferably 1 second or longer and 60 seconds or shorter and more preferably 2 seconds or longer and 30 seconds or shorter.

In addition, in this step, a plurality of types of the adhesive ink 3′ may be used.

### 1. 3. Thermal Transfer Step

In the thermal transfer step, the first layer and the second layer are thermally transferred onto fabric by heating the surface of the transfer medium on which the first layer and the second layer are formed in a state where the surface faces the fabric.

### 1. 3. 1. Fabric

The fabric is not particularly limited. The material constituting the fabric is also not particularly limited, examples thereof include natural fibers such as cotton, hemp, wool, and silk, synthetic fibers such as polypropylene, polyester, acetate, triacetate, polyamide, and polyurethane, and biodegradable fibers such as polylactic acid, and the material constituting the fabric may be mixed fibers thereof. The above-described fibers may be used in any form, such as woven fabric, knitted fabric, or non-woven fabric, and may be mixed and used as the fabric.

In the present embodiment, examples of the form of the fabric include fabric, clothing, and other furnishings. The fabric includes woven fabric, knitted fabric, non-woven fabric, and the like. Clothing and other furnishings include sewn products such as T-shirts, handkerchiefs, scarfs, towels, tote bags, fabric bags, curtains, sheets, bed covers, and furniture such as wallpaper, as well as fabric before and after cutting as parts before sewing. Examples of forms thereof include a long roll, a piece cut into a predetermined size, and a final product shape.

### 1. 3. 2. Heating Condition

The heating temperature in this step is not particularly limited, but is preferably 120° C. or higher and 270° C. or lower, more preferably 140° C. or higher and 250° C. or lower, and still more preferably 150° C. or higher and 210° C. or lower.

Consequently, productivity of the recorded matter 100 can be made more excellent with a reduced cost, while saving energy and suppressing the constituent materials of the first layer 2 and the second layer 3 from remaining on the transfer medium 1.

When the glass transition temperature of the thermoplastic resin included in the adhesive ink 3′ is denoted as Tg [° C.] and the heating temperature during the thermal transfer step is denoted as Tp [° C.], the relationship therebetween satisfies preferably 70≤Tp−Tg≤290, more preferably 95≤Tp−Tg≤260, and still more preferably 110≤Tp−Tg≤210. Consequently, amounts of the constituent materials of the first layer 2 and the second layer 3 remaining on the transfer medium 1 can be reduced, and productivity of the recorded matter 100 can be made more excellent, while saving energy.

The heating time in this step is not particularly limited, but is preferably 5 seconds or longer and 90 seconds or shorter, more preferably 15 seconds or longer and 70 seconds or shorter, and still more preferably 20 seconds or longer and 60 seconds or shorter.

This step may be performed in any manner as long as the surface of the transfer medium 1 on which the first layer 2 and the second layer 3 are formed is heated in a state where the surface faces the fabric 5, but is more preferably performed by heat pressing.

When this step is performed by heat pressing, the pressure applied to the stack of the transfer medium 1 and the fabric 5 is preferably 0.1 N/cm² or more and 30 N/cm² or less, more preferably 0.6 N/cm² or more and 15 N/cm² or less, and still more preferably 1.5 N/cm² or more and 5 N/cm² or less.

### 1. 4. Recorded Matter

Through the steps described above, the recorded matter 100 is obtained (1d). The recorded matter 100 obtained as described above has the recording portion 4 formed from the first layer 2 and the second layer 3.

At least a part of the recording portion 4 may penetrate into the inside of the absorptive fabric 5. At least a part of the recording portion 4 is usually formed by integrating the constituent materials of the first layer 2 and the constituent materials of the second layer 3; however, in the illustrated configuration, the entire of the recording portion 4 is formed by integrating the constituent materials of the first layer 2 and the constituent materials of the second layer 3.

### 1. 5. Application Amount and Other Parameters

In the transfer recording method of the present embodiment, the application amount of the adhesive ink in the second layer forming step is 38 g/m² or more. In addition, in the transfer recording method of the present embodiment, the total of the application amount of the image forming ink in the first layer forming step and the application amount of the adhesive ink in the second layer forming step is 212 g/m² or less. In this manner, bleeding of the image is suppressed without adjusting the evaporation ratio of the ink liquid component, and a high-quality image can be formed on fabric. When a plurality of types of the image forming ink is applied in the first layer forming step, the sum of the total application amount of the plurality of types of the image forming ink and the application amount of the adhesive ink in the second layer forming step is 212 g/m² or less.

The application amount of the adhesive ink in the second layer forming step is more preferably 47 g/m² or more and further preferably 57 g/m² or more. The upper limit of the application amount of the adhesive ink in the second layer forming step is not particularly limited, but is preferably 150 g/m² or less, more preferably 140 g/m² or less, and still more preferably 100 g/m² or less. In this manner, bleeding of the image is further suppressed without adjusting the evaporation ratio of the ink liquid component, and an image with higher quality can be formed on fabric.

On the other hand, the sum of the application amount of the image forming ink in the first layer forming step and the application amount of the adhesive ink in the second layer forming step is more preferably 210 g/m² or less, still more preferably 200 g/m² or less, and further preferably 180 g/m² or less. In this manner, bleeding of the image is further suppressed without adjusting the evaporation ratio of the ink liquid component, and an image with higher quality can be formed on fabric.

In addition, in the transfer recording method of the present embodiment, when the image forming ink further includes a thermoplastic resin, it is more preferable that the sum of the application amount of the image forming ink in the first layer forming step and the application amount of the adhesive ink in the second layer forming step be 76 g/m² or more. In this manner, transferability of the image can be further improved by the resin included in the image forming ink. In this case, the sum of the application amount of the image forming ink in the first layer forming step and the application amount of the adhesive ink in the second layer forming step is more preferably 90 g/m² or more, still more preferably 110 g/m² or more, and further preferably 130 g/m² or more.

When the amount of ink applied to an A4-size transfer medium is converted into duty, 19.24 g/m² corresponds to 100% duty.

As described above, according to the transfer recording method of the present embodiment, bleeding of the image is suppressed without adjusting the evaporation ratio of the ink liquid component, and a high-quality image can be formed on fabric, so that recording resolution can be increased. For example, even when the recording resolution is 600 dpi×600 dpi or more, preferably 720 dpi×720 dpi or more, a high-quality image can be formed on fabric. That is, when the recording resolution is high, the effect of the transfer recording method of the present embodiment becomes more remarkable.

### 2. Examples, Comparative Examples, and Reference Example

Hereinafter, the present disclosure will be described in more detail with reference to Examples and the like. However, the present disclosure is not limited to these Examples. Hereinafter, “%” is based on mass unless otherwise described.

### 2. 1. Preparation of Adhesive Ink

Adhesive ink 1 to adhesive ink 11 were obtained by mixing components so as to achieve the compositions shown in Table 1. Details of the components in Table 1 are as follows.
Polyester resin Z-687: manufactured by GOO Chemical Co., Ltd., solid (softening point: 185° C. to 200° C.)
Polyester resin RZ-570: manufactured by GOO Chemical Co., Ltd., solid (softening point: 160° C. to 170° C.)
Polyester resin Z-880: manufactured by GOO Chemical Co., Ltd., solid (softening point: 85° C. to 95° C.)
Urethane resin: water-dispersed product of a polyurethane prepolymer (softening point: 100° C.) having a number average molecular weight of 10000, where the polyurethane prepolymer was prepared by reacting at 100° C. for 4 to 8 hours while mixing and stirring: 86 parts by weight of a bifunctional polyester polyol which had a molecular weight of 2000, mainly included adipic acid, isophthalic acid, 1,4-butanediol, and ethylene glycol, and was obtained by polymerization with 15 mol % of the isophthalic acid component based on the all components mixed; 14 parts by weight of xylylene diisocyanate, 1 part by weight of vinyltris(2-methoxyethoxy) silane, and 0.01 parts by weight of dibutyltin dilaurate
Acrylic resin: into a 2 L glass flask equipped with a stirrer, a thermometer, and a reflux condenser, was added 104 parts by mass of ion-exchanged water, and deoxidization was carried out. To a mixture of 57 parts by mass of ethyl acrylate, 42 parts by mass of methyl methacrylate, and 1 part by mass of 80% methacrylic acid, was added 2 parts by mass of HITENOL HS-10 (manufactured by DKS Co. Ltd., polyoxyethylene nonyl propenyl phenyl ether sulfate ammonium) dissolved in 26 parts by mass of ion-exchanged water, followed by emulsification with a homomixer to obtain emulsion. Acrylic resin emulsion (emulsion of ethyl acrylate-methyl methacrylate copolymer resin) was obtained through radical polymerization caused by carrying out redox reaction at 50° C. in the presence of a peroxide and a reducing agent so that the softening point became 100° C., while dropping the emulsion obtained above into a 2 L glass flask over 5 to 10 hours.
Vinyl chloride resin: vinyl chloride-based resin emulsion (emulsion of vinyl chloride-acrylic acid copolymer resin) obtained as follows: a polymerization vessel equipped with a stirrer, a condenser, a thermometer, and a nitrogen gas inlet was purged with nitrogen; 67 parts by mass of ion-exchanged water, 4 parts by mass of PELEX SS-L (anionic surfactant manufactured by Kao Corporation, sodium alkyl diphenyl ether disulfonate), 5 parts by mass of NOIGEN L-6190 (nonionic surfactant manufactured by DKS Co. Ltd.), 52 parts by mass of vinyl chloride, and 48 parts by mass of 2-ethylhexyl acrylate were put into the polymerization vessel, followed by heating to 60° C. while stirring; a solution obtained by dissolving 0.3 parts by mass of ammonium persulfate (initiator) in 10 parts by mass of ion-exchanged water and a solution obtained by dissolving 0.1 parts by mass of sodium hydrogen sulfite in 3 parts by mass of ion-exchanged water were added thereto; polymerization reaction was carried out in a redox system for 5 to 20 hours so that the softening point became 100° C.; at the time when the polymerization internal pressure became 0 MPa, the remaining monomers were removed to 1000 ppm under vacuum, followed by cooling to 40° C. or lower to obtain a polymer; and a preservative or ion-exchanged water were then added to the polymer.
SAG503A: surfactant, SILFACE SAG503A (manufactured by Nissin Chemical Industry Co., Ltd.)

### 2.2. Preparation of Image Forming Ink

Color ink and white ink were obtained by mixing components so as to achieve the compositions shown in Table 2. Details of the components in Table 2 are as follows.
Urethane resin: WS-5100 manufactured by Mitsui Chemicals, Inc., solid
Carbon black: Microjet CW1 manufactured by ORIENT CHEMICAL INDUSTRIES CO., LTD.
BYK-348: silicone-based surfactant manufactured by BYK Japan KK
Titanium dioxide dispersion A: the dispersion prepared as follows was used.

C.I. Pigment White 6 (specific gravity: 4.2 g/mL) was used as a pigment, and an anionic resin dispersant was used as a pigment dispersant. Specifically, a styrene-acrylic resin synthesized using 55% by mass of styrene, 20% by mass of acrylic acid, and 30% by mass of methyl methacrylate was used. One part by mass of the dispersant and 10 parts by mass of ion-exchanged water based on 3 parts by mass of the pigment were used for mixing, the resultant mixture was premixed and then dispersed with zirconia beads having a diameter of 0.03 mm at a circumferential velocity of 10 m/s and a liquid temperature of 30° C. for 15 minutes using a bead mill disperser (UAM-015 manufactured by KOTOBUKI KOGYOU Co., Ltd.), and coarse particles were centrifuged using a centrifuge (Model-3600, manufactured by KUBOTA CORPORATION) to obtain a titanium oxide dispersion.

### 2. 3. Evaluation Methods

### 2. 3. 1. Production of Recorded Matter

First, a transfer medium (DTF printing film manufactured by inkmania limited liability company) in which a release layer composed of a release agent was provided on a base material composed of polyethylene terephthalate was prepared.

Thereafter, an ink jet recording device (SC-F2150 manufactured by Seiko Epson Corporation) was filled with the color ink (first image forming ink), the white ink (second image forming ink), and the corresponding adhesive ink as shown in Tables 3 and 4, and the color ink and the white ink in the ejection amounts shown in Tables 3 and 4 were discharged from the ink jet head onto the surface of the transfer medium on which the release layer was provided to form a first layer having a predetermined pattern.

Thereafter, the corresponding adhesive ink shown in Tables 3 and 4 was discharged from the ink jet head in the ejection amount shown in Tables 3 and 4 to form a second layer having the same pattern as that of the first layer so that the second layer was superimposed on the first layer. The obtained transfer medium was dried at 160° C. for 5 minutes.

Thereafter, heat treatment was performed at 180° C. for 40 seconds in a state where the surface of the transfer medium on which the first layer and the second layer were formed faced cotton broadcloth (#4000) manufactured by Nisshinbo Holdings Inc., which was fabric, thereby thermally transferring the first layer and the second layer onto the fabric. Thereafter, the transfer medium was removed to obtain a recorded matter.

In Reference Example, a recorded matter was produced in the same manner as in Examples except that a second layer having the same pattern as that of the first layer was formed using thermoplastic resin powder (EcoFreen Fine Grain TPU Hot Melt Powder (white) manufactured by ECOFREEN) without using the adhesive ink.

### 2. 3. 2. Evaluation of Dischargeability (Adhesive Ink)

With respect to the adhesive ink, continuous printing stability was evaluated as evaluation of dischargeability. An ink jet printer (product name: PX-G930, manufactured by Seiko Epson Corporation) was filled with the adhesive ink, and recording was performed on a recording medium (DTF printing film manufactured by inkmania limited liability company). Specifically, a solid pattern capable of recording at 100% duty at resolution of 720 dpi by 720 dpi was prepared and used. Printing was performed on 100 sheets in A4 size, and the presence or absence of misalignments and nozzle dropouts were confirmed. The results were evaluated according to the following criteria and are shown in Tables 3 and 4.
A: discharge is possible without any abnormalities.
B: discharge is possible even misalignments and nozzle dropouts are caused.
C: discharge is impossible.

### 2. 3. 3. Evaluation of Transferability

In each example, the state of separation from the transfer medium was visually confirmed when transferring onto the fabric, and the transferability (peelability) was evaluated according to the following criteria, and the results are shown in Tables 3 and 4.
AA: 100% of printed image area is transferred.
A: 80% or more and less than 100% of printed image region is transferred.
B: 50% or more and less than 80% of printed image region is transferred.
C: less than 50% of printed image region is transferred.

### 2. 3. 4. Evaluation of Image Quality

An ink jet printer (product name: PX-G930, manufactured by Seiko Epson Corporation) was filled with each ink composition, and recording was performed on a recording medium (DTF printing film manufactured by inkmania limited liability company). Specifically, a solid pattern capable of recording at 100% duty at resolution of 720 dpi by 720 dpi was prepared and used. Ink overflowing from the solid pattern on the recorded matter and aggregation unevenness were visually observed and evaluated according to the following criteria. Incidentally, this evaluation was conducted in a laboratory under room temperature (25° C.) condition.
A: no abnormalities
B: image distortion is slightly observed
C: image distortion is clearly observed

### 2. 3. 5. Evaluation of Color Development

With respect to the transfer substrate according to each of Examples and Comparative Examples, color developability was evaluated. Specifically, the OD value of the recording portion of each transfer substrate was determined by measurement using a spectrodensitometer FD-7 (manufactured by KONICA MINOLTA JAPAN, INC.) and evaluated according to the following criteria. It can be said that the larger the value is, the better the color developability is. A rating of B or higher was considered a good level. Incidentally, the evaluation result “B*¹” of Example 4 is an evaluation result relating to color development of the white ink.

### Evaluation Criteria

A: OD value is 1.3 or more
B: OD value is 1.0 or more and less than 1.3
C: OD value is less than 1.0

### 2. 3. 6. Evaluation of Texture

With respect to the recorded matter in each example, texture was evaluated. Each recorded matter was subjected to sensory evaluation by a specific evaluator according to the following criteria to evaluate the texture. The evaluation results indicate that the texture is improved in the order of C, B, and A. The evaluation result of A or B indicates that a good effect is obtained. Incidentally, “C*²” in Reference Example indicates “hard.”
A: soft, with no rough texture felt
B: slightly hard, with little rough texture felt
C: rough texture is significantly felt

### 2. 3. 7. Evaluation of Image Quality at Image Edge

An ink jet printer (product name: PX-G930, manufactured by Seiko Epson Corporation) was filled with each ink composition, and recording was performed on a recording medium (DTF printing film manufactured by inkmania limited liability company). Specifically, a solid pattern capable of recording at 100% duty at resolution of 720 dpi by 720 dpi was prepared and used. Hot melt powder (EcoFreen Fine Grain TPU Hot Melt Powder (white), manufactured by ECOFREEN) was uniformly sprinkled on the recorded matter, and unnecessary powder was brushed away. Incidentally, “C*³” in Reference Example indicates that “stain is present.”
A: no powder stain
B: powder stain is slightly observed
C: powder stain is clearly observed

### 2. 4. Evaluation Results

In each of Examples in which the solid content of the thermoplastic resin was 5% by mass or more and 25% by mass or less based on the total amount of the adhesive ink, the application amount of the adhesive ink in the second layer forming step was 38 g/m² or more, and the sum of the application amount of the image forming ink in the first layer forming step and the application amount of the adhesive ink in the second layer forming step was 212 g/m² or less, it was found that bleeding of the image was suppressed and a high-quality image can be formed on the fabric. Note that, in Table 4, the symbol “-” in the cells of the evaluation result indicates “undeterminable.”

The above-described embodiment and modifications are merely examples, and the present disclosure is not limited thereto. For example, the embodiment and the modifications may be appropriately combined.

The present disclosure includes a configuration substantially the same as the configuration described in the embodiment, for example, a configuration having the same function, method, and result, or a configuration having the same object and effect. In addition, the present disclosure includes a configuration in which a non-essential portion of the configuration described in the embodiment is replaced. In addition, the present disclosure includes a configuration that can provide the same function and effect or a configuration that can achieve the same object as the configuration described in the embodiment. Further, the present disclosure includes a configuration in which a known feature is added to the configuration described in the embodiment.

The following contents are derived from the above-described embodiment and modifications.

A transfer recording method includes a first layer forming step of discharging an image forming ink from an ink jet head onto a transfer medium having a release layer to form a first layer, a second layer forming step of discharging an adhesive ink from the ink jet head to form a second layer so as to be superimposed on the first layer, and a thermal transfer step of thermally transferring the first layer and the second layer onto fabric by heating a surface of the transfer medium on which the first layer and the second layer are formed in a state where the surface faces the fabric, in which the image forming ink includes a color material and water, the adhesive ink includes a thermoplastic resin and water, the softening point of the thermoplastic resin is equal to or lower than the temperature for heating the fabric in the thermal transfer step, the solid content of the thermoplastic resin is 5% by mass or more and 25% by mass or less based on the total amount of the adhesive ink, the application amount of the adhesive ink in the second layer forming step is 38 g/m² or more, and the sum of the application amount of the image forming ink in the first layer forming step and the application amount of the adhesive ink in the second layer forming step is 212 g/m² or less.

According to this transfer recording method, bleeding of the image is suppressed without adjusting the evaporation ratio of the ink liquid component, and a high-quality image can be formed on the fabric.

In the above-described transfer recording method, the first layer may be formed by discharging a first image forming ink including a chromatic color material and a second image forming ink including a white pigment in a superimposed manner in the first layer forming step.

According to this transfer recording method, when the second image forming ink (white ink) is discharged in a superimposed manner in addition to the first image forming ink (color ink), the total amount of deposited ink increases; therefore, image bleeding is suppressed, allowing for formation of a high-quality image even in such a case.

In the above-described transfer recording method, the thermoplastic resin may be one or more kinds selected from a polyester resin, a urethane resin, an acrylic resin, and a vinyl chloride resin.

According to this transfer recording method, transfer can be performed more favorably.

In the above-described transfer recording method, the thermoplastic resin may have a softening point of 80° C. or higher and 170° C. or lower.

According to this transfer recording method, tackiness of a transfer substrate can be further suppressed, and damage to fabric due to heat during thermal transfer can be further reduced.

In the above-described transfer recording method, the image forming ink may further include a thermoplastic resin, and the sum of the application amount of the image forming ink in the first layer forming step and the application amount of the adhesive ink in the second layer forming step may be 76 g/m² or more.

According to this transfer recording method, transferability of the image can be further improved by the resin included in the image forming ink.

In the above-described transfer recording method, the recording resolution may be 600 dpi×600 dpi or more.

According to this transfer recording method, a finer image can be formed with image bleeding suppressed.

What is claimed is:

1. A transfer recording method, comprising:
a first layer forming step of discharging an image forming ink from an ink jet head onto a transfer medium having a release layer to form a first layer;
a second layer forming step of discharging an adhesive ink from the ink jet head to form a second layer so as to be superimposed on the first layer; and
a thermal transfer step of thermally transferring the first layer and the second layer onto fabric by heating a surface of the transfer medium on which the first layer and the second layer are formed in a state where the surface faces the fabric, wherein
the image forming ink includes a color material and water,
the adhesive ink includes a thermoplastic resin and water,
a softening point of the thermoplastic resin is equal to or lower than the temperature for heating the fabric in the thermal transfer step,
a solid content of the thermoplastic resin is 5% by mass or more and 25% by mass or less based on a total amount of the adhesive ink,
an application amount of the adhesive ink in the second layer forming step is 38 g/m² or more, and
the sum of an application amount of the image forming ink in the first layer forming step and the application amount of the adhesive ink in the second layer forming step is 212 g/m² or less.

2. The transfer recording method according to claim 1, wherein
the first layer is formed by discharging a first image forming ink including a chromatic color material and a second image forming ink including a white pigment in a superimposed manner in the first layer forming step.

3. The transfer recording method according to claim 1, wherein
the thermoplastic resin is one or more kinds selected from a polyester resin, a urethane resin, an acrylic resin, and a vinyl chloride resin.

4. The transfer recording method according to claim 1, wherein
the thermoplastic resin has a softening point of 80° C. or higher and 170° C. or lower.

5. The transfer recording method according to claim 1, wherein
the image forming ink further includes a thermoplastic resin, and
the sum of an application amount of the image forming ink in the first layer forming step and an application amount of the adhesive ink in the second layer forming step is 76 g/m² or more.

6. The transfer recording method according to claim 1, wherein
recording resolution is 600 dpi×600 dpi or more.
